(19) United States
(12) Patent Application Publication
(10) Pub. No.: US 2026/0299241 A1
(43) Pub. Date: Oct. 1, 2026

(54) OPTICAL PANEL

(71) Applicants: NIPPON TSUSHIN DENZAI CO., LTD., Komaki-shi, Aichi (JP); SUMITOMO ELECTRIC INDUSTRIES, LTD., Osaka-shi, Osaka (JP)

(72) Inventors: Kamui ARIMURA, Komaki-shi (JP); Hisahiko NARUKAMWA, Osaka-shi (JP); Tuan Nghia DUONG, Komaki-shi (JP); Shinskue SATO, Komaki-shi (JP); Yuji MATSUMOTO, Komaki-shi (JP)

(21) Appl. No.: 19/489,107

(22) PCT Filed: May 31, 2024
(86) PCT No.: PCT/JP2024/020064

§ 371 Date: Dec. 1, 2025

(30) Foreign Application Priority Data
Feb. 6, 2023 (JP) 2023-091708

(51) Int. Cl. G02B 6/44

(52) U.S. Cl. CPC G02B 6/44524; G02B 6/44526

(57) ABSTRACT

An optical panel includes: a holder configured to hold an optical fiber cable; and a housing configured to allow an optical fiber led from the optical fiber cable to be arranged inside the housing. The housing is provided with a plurality of attachment portions. The holder includes a plurality of fixing portions engageable with the attachment portions of the housing. The number of the attachment portions is greater than the number of the fixing portions.

### TECHNICAL FIELD

The present disclosure relates to an optical panel. This application claims priority based on Japanese Patent Application No. 2023-091708 filed on Jun. 2, 2023, the entire contents of which are incorporated herein by reference.

Conventionally, there is known an optical panel including an adapter to which an optical connector attached to a distal end of an optical fiber is connected, and a wiring plate at which the optical fiber is arranged. Patent literature 1 discloses an optical cabinet including a wiring plate at which an optical fiber is arranged and a cable fixing portion that fixes the optical fiber cable to the wiring plate in a cabinet body into which an optical fiber cable is introduced. In the optical cabinet as described in Patent Literature 1, the optical fiber cable is fixed to the cable fixing portion, and then the optical fiber led from the optical fiber cable is arranged at the wiring plate.

### CITATION LIST

### Patent Literature

Patent literature 1: JP2001-264545A

Patent literature 2: U.S. Pat. No. 10,481,358B

### SUMMARY OF INVENTION

An optical panel according to the present disclosure includes a holder that holds an optical fiber cable, and a housing that allows an optical fiber led from the optical fiber cable to be arranged inside the housing. The housing is provided with a plurality of attachment portions. The holder includes a plurality of fixing portions engageable with the attachment portions of the housing. The number of the attachment portions is greater than the number of the fixing portions.

### BRIEF DESCRIPTION OF THE DRAWINGS

FIG. 1 is a perspective view showing a configuration of an optical panel according to an embodiment of the present disclosure.

FIG. 2 is a top view showing an internal configuration of a housing shown in FIG. 1 and a state in which an optical fiber led out from an optical fiber cable is arranged inside the housing.

FIG. 3 is a rear view of the optical panel shown in FIG. 1.

FIG. 4 is a partially enlarged view showing a detailed configuration of a base portion and a holder shown in FIG. 2.

FIG. 5 is a partially enlarged view showing an example of a state in which a position of the holder has been changed from the state shown in FIG. 4.

FIG. 6 is a partially enlarged view (part 1) showing an example of a state in which an inclination of the holder has been changed from the state shown in FIG. 4.

FIG. 7 is a partially enlarged view (part 2) showing an example of a state in which an inclination of the holder has been changed from the state shown in FIG. 4.

### DETAILED DESCRIPTION

### Problems to Be Solved by Present Disclosure

Bending strain applied to an area of or near a portion of the fixed optical fiber cable at which the optical fiber is led may become too large, for example, when the optical fiber cable is bent with a small radius of curvature in accordance with the distance and angle of a wiring route of the optical fiber.

An object of the present disclosure is to provide an optical panel that can fix an optical fiber cable such that bending strain applied to an area of or near a portion of the optical fiber cable at which an optical fiber is led is reduced.

### Advantageous Effects of Present Disclosure

According to the present disclosure, it is possible to fix an optical fiber cable such that bending strain applied to an area of or near a portion of the optical fiber cable at which an optical fiber is led is reduced.

### Description of Embodiments of Present Disclosure

First, embodiments of the present disclosure will be listed and described.

An optical panel according to an embodiment of the present disclosure includes (1) a holder that holds an optical fiber cable, and a housing that allows an optical fiber led from the optical fiber cable to be arranged inside the housing. The housing is provided with a plurality of attachment portions. The holder includes a plurality of fixing portions engageable with the attachment portions of the housing. The number of the attachment portions is greater than the number of the fixing portions.

With this configuration, a position of the holder with respect to the housing can be adjusted by selecting the attachment portion with which the fixing portion of the holder is to be engaged from the plurality of attachment portions provided in the housing. Thus, the optical fiber cable can be fixed such that bending strain applied to an area of or near a portion of the optical fiber cable at which the optical fiber is led is reduced.

(2) In the optical panel according to the above (1), the plurality of attachment portions may be aligned in two directions differing from each other.

With this configuration, an inclination of the holder with respect to the housing can be adjusted.

(3) In the optical panel according to the above (1) or (2), the holder may be mounted outside the housing.

Since the optical fiber is arranged inside the housing, the configuration in which the holder is mounted outside the housing as described above enables the attachment position of the holder to be set more flexibly than in a configuration where the holder is mounted inside the housing.

(4) In the optical panel according to any one of the above (1) to (3), the holder may further include a positioning portion that secure a position of the optical fiber cable, and a supporting portion to which the fixing portions are attached and that supports the positioning portion. An orientation of the positioning portion with respect to the supporting portion may be changeable.

For example, there may be a case in which one holder fixes an optical fiber cable introduced from a left side of the housing, and another holder fixes an optical fiber cable introduced from a right side of the housing. Even in such a case, by changing the orientation of the positioning portion with respect to the supporting portion of each holder, these optical fiber cables can be fixed to the housing using respective holders having the same configuration.

(5) In the optical panel according to any one of the above (1) to (4), the optical fiber cable may be held outside the housing by the holder. The housing may have a fiber introduction port at a center of a surface of the housing at which the holder is provided. The optical panel may further include a first fiber fixing portion that retain the optical fiber led from an end portion of the optical fiber cable held by the holder such that the optical fiber extends toward the fiber introduction port, and a second fiber fixing portion that retains the optical fiber introduced into the fiber introduction port and provided close to the fiber introduction port inside the housing.

With this configuration, the optical fiber led from the end portion of the optical fiber cable is guided to the fiber introduction port by the first fiber fixing portion, and is further retained by the second fiber fixing portion close to the fiber introduction port and guided into the housing. Thus, regardless of an introduction direction of the optical fiber cable, the optical fiber can be guided to the fiber introduction port formed at the center of the surface of the housing.

(6) In the optical panel according to any one of the above (1) to (5), the optical fiber cable may be held outside the housing by the holder. The optical panel may further include a cover that covers a portion of the optical fiber led from the optical fiber cable and located outside the housing.

This enables the optical fiber led from the optical fiber cable to reduce contact with other components or the like outside the housing, even when the optical fiber cable is fixed outside the housing.

### Details of Embodiments of Present Disclosure

Specific examples of an optical panel of the present disclosure will be described below with reference to the drawings. The present disclosure is not limited to these examples, but is defined by the scope of the claims, and is intended to include all modifications within the meaning and scope equivalent to the scope of the claims.

In the following description, the terms “front”, “back”, “left”, “right”, “up”, and “down” may be used, but these directions are relative directions set for convenience of description. In each figure, “F” represents “front”, “B” represents “back”, “L” represents “left”, “R” represents “right”, “U” represents “up”, and “D” represents “down”. In the following description, the term “horizontal direction” refers to a direction including “left” and “right”. The term “vertical direction” refers to a direction including “up” and “down”.

### Overall Configuration

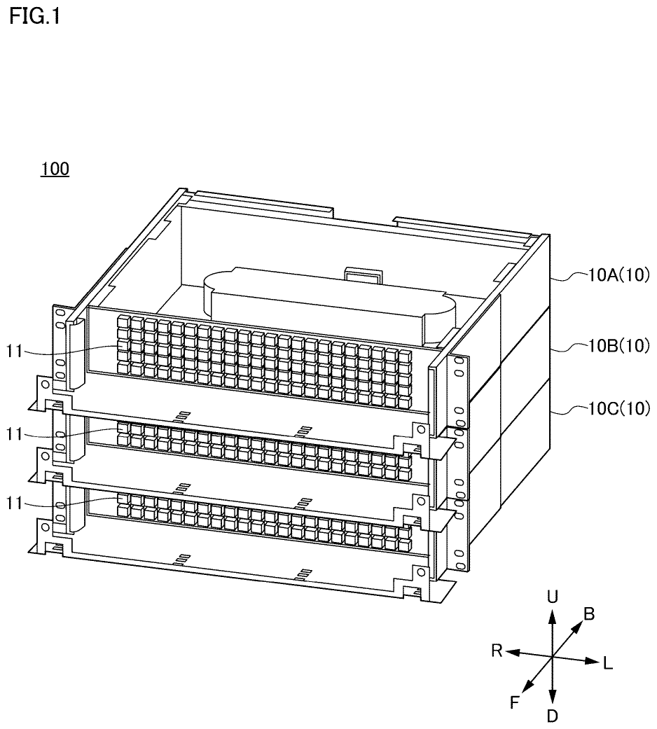

FIG. 1 is a perspective view showing a configuration of an optical panel 100 according to an embodiment of the present disclosure. The optical panel 100 includes a plurality of housings 10 stacked in a vertical direction. In FIG. 1, as an example, three housings 10, which are housings 10A, 10B, and 10C, are stacked from bottom to top in the order of the housing 10C, the housing 10B, and the housing 10A. A plurality of adapters 11 are provided in front of each of the housings 10.

An optical fiber led out from an optical fiber cable described later is arranged inside each of the housings 10. For example, an optical connector attached to an end portion of each optical fiber is connected to each of the adapters 11.

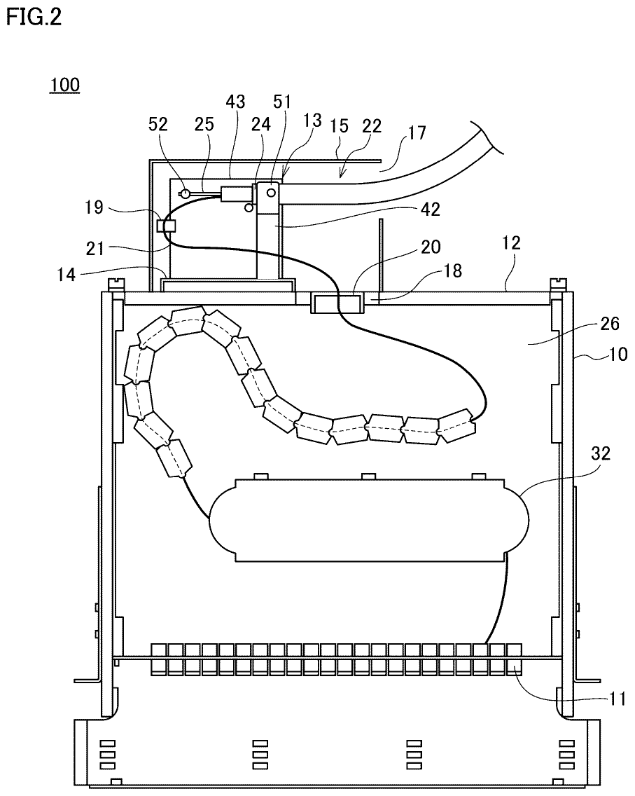

FIG. 2 is a top view showing am internal configuration of each of the housings 10 shown in FIG. 1 and a state in which an optical fiber 21 led out from an optical fiber cable 22 is arranged inside each of the housings 10. As shown in FIG. 2, a holder 13 that holds the optical fiber cable 22 and a base portion 14 that mounts the holder 13 on each of the housings 10 are provided outside a back surface 12 of each of the housings 10.

The optical panel 100 is provided with a first fiber fixing portion 19 and a second fiber fixing portion 20 to fix the optical fiber 21 led out from the optical fiber cable 22. An opening (fiber introduction port) 18 is formed at a substantially center of the back surface 12 of each of the housings 10 in the horizontal direction. For example, the first fiber fixing portion 19 is provided close to the holder 13, and the second fiber fixing portion 20 is provided close to the opening 18.

At an end portion of the optical fiber cable 22 fixed by the holder 13, a jacket 24 is removed, and the optical fiber 21 and a tension member 25 are led. Furthermore, a cover 15 is provided outside the back surface 12 of each of the housings 10 to cover the holder 13, and the optical fiber 21 and the tension member 25 which are led from the optical fiber cable 22. This enables the optical fiber 21 and the tension member 25 to reduce contact with other components or the like outside the housing 10.

An insertion hole 17 is formed at a part of the cover 15. The optical fiber cable 22 extends toward the holder 13 inside the cover 15 through the insertion hole 17.

The optical fiber 21 led from the optical fiber cable 22 is fixed to the first fiber fixing portion 19 and the second fiber fixing portion 20 and guided into each of the housings 10. The optical fiber 21, for example, passes through a tray 32 while being bent inside each of the housings 10, and is connected to an optical fiber on a downstream side in the tray 32 as appropriate and extends toward each of the adapters 11. Although one optical fiber 21 is shown in FIG. 2, a plurality of optical fibers 21 may be arranged inside each of the housings 10.

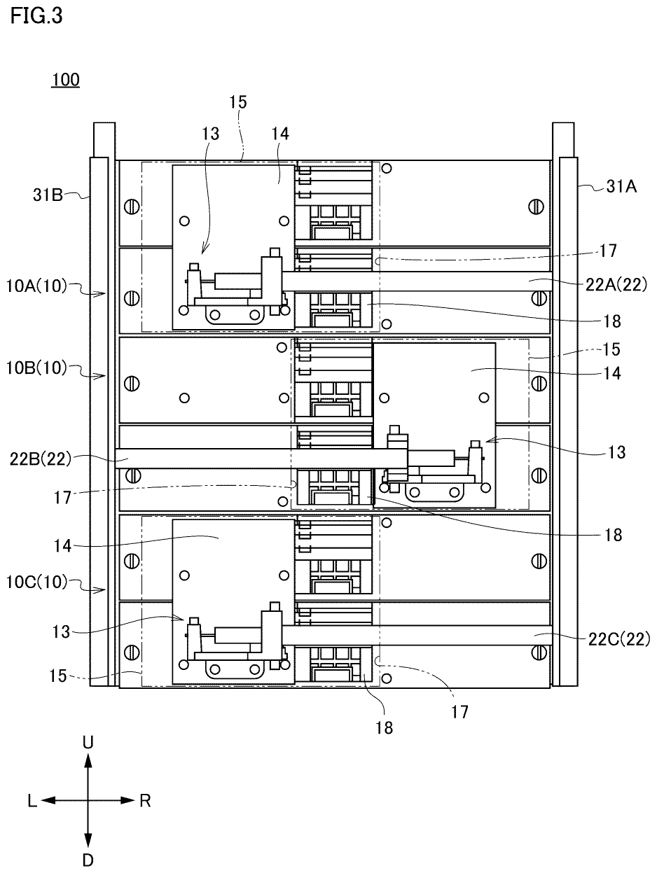

FIG. 3 is a rear view of the optical panel 100 shown in FIG. 1. In FIG. 3, the cover 15 is indicated by a dashed line in order to show the holder 13 and the base portion 14. As shown in FIG. 3, mount angles 31A and 31B through which one or a plurality of optical fiber cables 22 is inserted are provided on the left and right sides of the optical panel 100.

In the example shown in FIG. 3, two optical fiber cables 22A and 22C, which are the optical fiber cables 22, are inserted through the mount angle 31A provided on the right side of the optical panel 100. Furthermore, one optical fiber cable 22B, which is the optical fiber cable 22, is inserted through the mount angle 31B provided on the left side of the optical panel 100.

In each of the housings 10A and 10C, the base portion 14 is provided on the left side of the opening 18 of the back surface 12, and the holder 13 is provided on the back surface 12 with the base portion 14 interposed therebetween. Each of the two optical fiber cable 22A and 22C inserted through the mount angle 31A extends toward the holder 13, which is provided inside the cover 15, through the insertion hole 17 of the cover 15 provided at the back surface of each of the housings 10A and 10C.

In the housing 10B, the base portion 14 is provided on the right side of the opening 18 of the back surface 12, and the holder 13 is provided on the back surface 12 with the base portion 14 interposed therebetween. The optical fiber cable 22B inserted through the mount angle 31B extends toward the holder 13 provided inside the cover 15 through the insertion hole 17 of the cover 15 provided on the housing 10B.

### Detailed Configuration of Base Portion and Holder

### (a) Base Portion

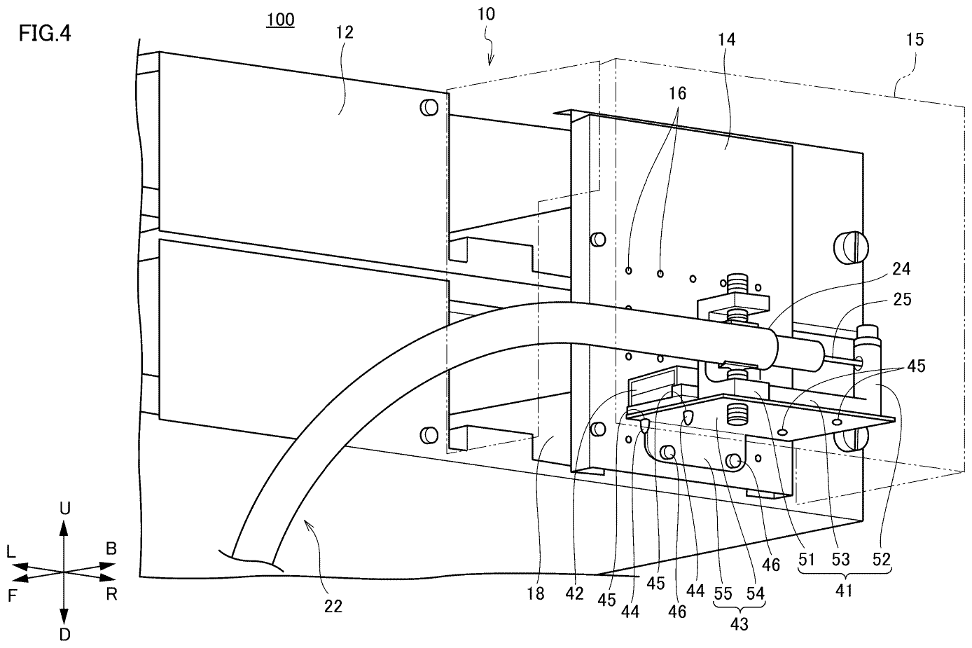

FIG. 4 is a partially enlarged view showing a detailed configuration of the base portion 14 and the holder 13 shown in FIG. 2. In FIG. 4, the cover 15 is indicated by a dashed line, and the optical fiber 21 is not shown. As shown in FIG. 4, a plurality of first holes (attachment portions) 16 are formed in the base portion 14. The plurality of first holes 16 are, for example, tap holes, and formed side by side in two directions differing from each other. Specifically, as an example, 25 first holes 16, which are aligned in five rows in the vertical direction and five rows in the horizontal direction, are formed at intervals of 20 mm therebetween.

### (b) Holder

The holder 13 includes a positioning portion 41 that secures a position of the optical fiber cable 22, an attachment portion 42 provided between the positioning portion 41 and the base portion 14, and a supporting portion 43 that supports the positioning portion 41 and the attachment portion 42. The positioning portion 41 includes a first positioning portion 51 that fixes the jacket 24 of the optical fiber cable 22, a second positioning portion 52 that fixes the tension member 25 led from the optical fiber cable 22, and a coupling portion 53 that couples the first positioning portion 51 with the second positioning portion 52.

The attachment portion 42 is coupled to the front of the first positioning portion 51 in the positioning portion 41, for example. A plurality of fitting portions 44 protruding downward are provided on a lower surface of the attachment portion 42. In the example shown in FIG. 4, the two fitting portions 44 aligned in a front-back direction are provided.

The supporting portion 43 has a plate portion 54 having a plate-like shape and an extension portion 55 extending downward at a front end portion of the plate portion 54. A plurality of second holes 45 are formed in the plate portion 54. For example, each of the two fitting portions 44 of the attachment portion 42 is fitted into a respective one of two second holes 45, which aligned in the front-back direction close to the left end portion of the plate portion 54 among the plurality of second holes 45. Thereby, the attachment portion 42 and the positioning portion 41 coupled with the attachment portion 42 are attached to the supporting portion 43.

A plurality of screws (fixing portions) 46 engageable with the first holes 16 of the base portion 14 are attached to the extension portion 55 of the supporting portion 43. The number of screws 46 is smaller than the number of first holes 16 formed in the base portion 14. For example, as shown in FIG. 4, the number of the first holes 16 is 25, and the number of the screws 46 is two.

Each of the two screws 46 is engaged with a respective one of two first holes among the 25 first holes 16 in the base portion 14, so that the holder 13 is attached to the base portion 14. In the example shown in FIG. 4, each of the two screws 46 is engaged with a respective one of the two first holes 16, which are aligned in the horizontal direction in the lowermost row among the 25 first holes 16.

(b-1) Change of Orientation of Positioning Portion with Respect to Supporting Portion

Orientations of the positioning portion 41 and the attachment portion 42 can be changed with respect to the supporting portion 43 that supports the positioning portion 41 and the attachment portion 42. More specifically, the plurality of second holes 45 formed in the plate portion 54 of the supporting portion 43 include two second holes 45 aligned in the front-back direction close to the left end portion, as well as two second holes 45 aligned in the front-back direction close to the right end portion. In the example shown in FIG. 4, as described above, each of the two fitting portions 44 in the attachment portion 42 of the positioning portion 41 is fitted into a respective one of the two second holes 45, which are aligned close to the left end portion of the plate portion 54.

In this case, in the holder 13, the first positioning portion 51 is positioned on the left side and the second positioning portion 52 is positioned on the right side. By using the holder 13 assembled in this manner, the optical fiber cable 22, which is introduced from the left side with respect to the housing 10 as in the optical fiber cable 22B shown in FIG. 3, can be fixed.

When each of the two fitting portions 44 of the attachment portion 42 is fitted into a respective one of the two second holes 45, which are aligned close to the right end portion of the plate portion 54, the first positioning portion 51 is positioned on the right side in the holder 13, and the second positioning portion 52 is positioned on the left side in the holder 13. By using the holder 13 assembled in this manner, the optical fiber cable 22, which is introduced from the right side with respect to the housing 10 as in the optical fiber cables 22A and 22C shown in FIG. 3, can be fixed.

That is, as described above, the orientation of the positioning portion 41 is changeable with respect to the supporting portion 43, so that the optical fiber cable 22 can be fixed to the housing 10 using the holder 13 having the same configuration regardless of an introduction direction of the optical fiber cable 22.

(b-2) Adjustment of Position and Inclination of Holder

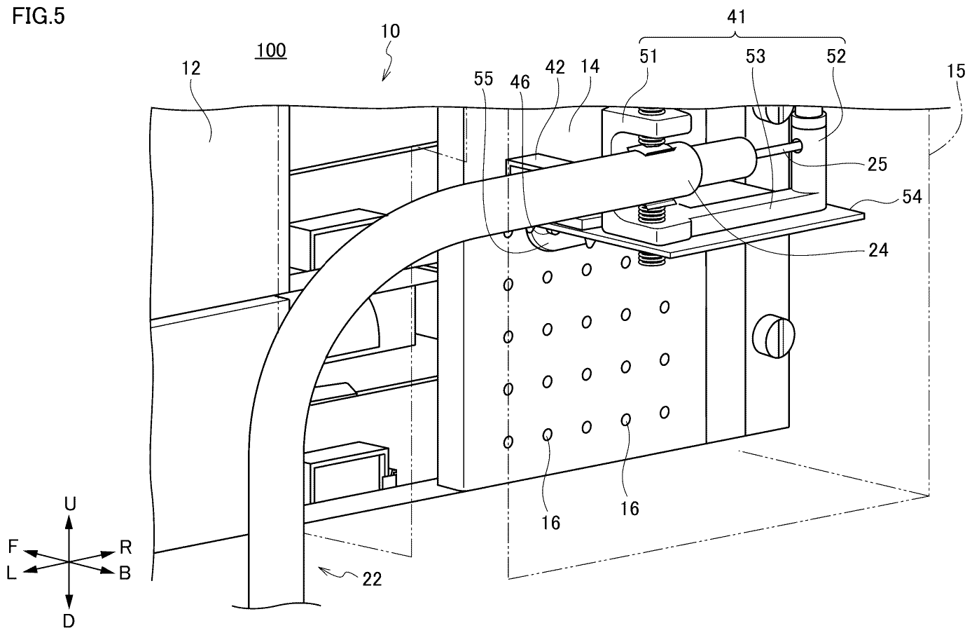

FIG. 5 is a partially enlarged view showing an example of a state in which a position of the holder 13 has been changed from the state shown in FIG. 4. In FIG. 5, the cover 15 is indicated by a dashed line, and the optical fiber 21 is not shown, as in FIG. 4. In the example shown in FIG. 5, each of the two screws 46 of the holder 13 is inserted into a respective one of two first holes 16, which aligned in the horizontal direction in the uppermost row among the plurality of first holes 16 formed in the base portion 14. As a result, the holder 13 can be positioned more upward than in the case shown in FIG. 4.

Since the plurality of first holes 16 are aligned in the vertical direction in this manner, the position of the holder 13 in the vertical direction with respect to the housing 10 can be adjusted by selecting the first holes 16 with which the screws 46 are to be engaged. Similarly, in the horizontal direction, since the plurality of first holes 16 are aligned in the horizontal direction, the position of the holder 13 in the horizontal direction with respect to the housing 10 can be adjusted by selecting the first holes 16 with which the screws 46 are to be engaged.

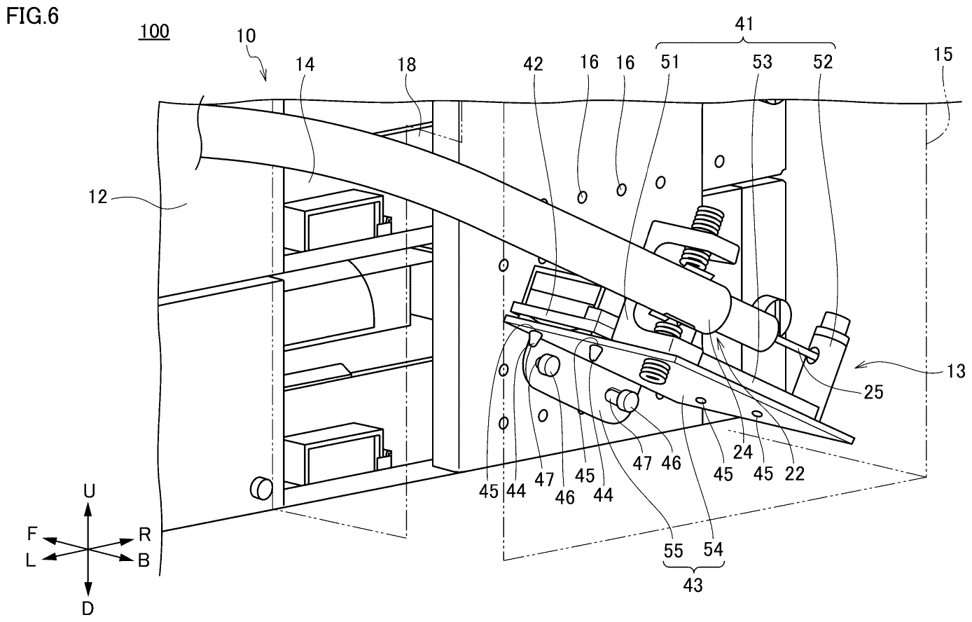

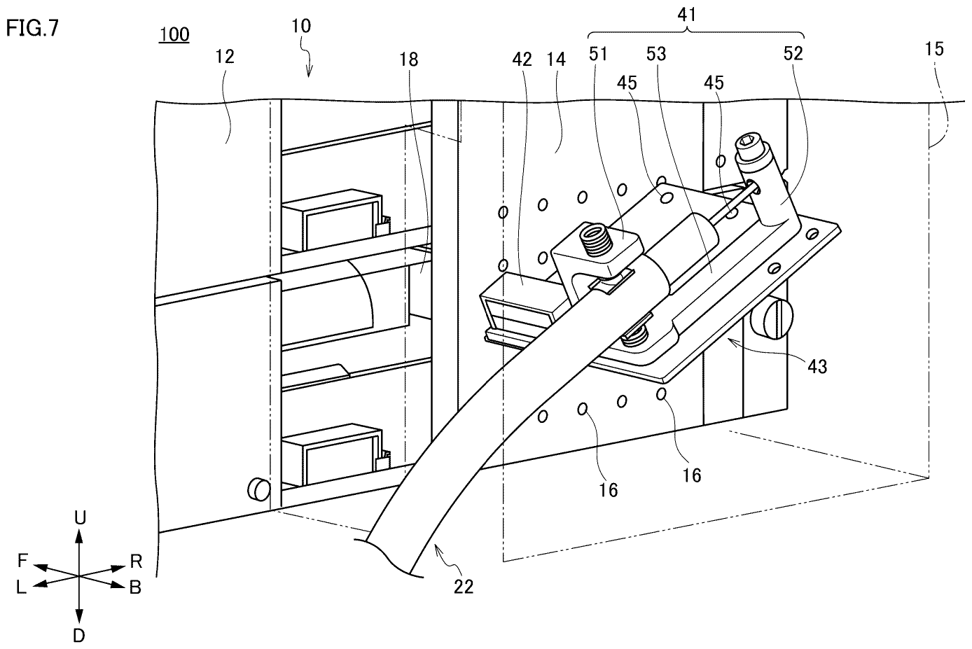

FIG. 6 and FIG. 7 are partially enlarged views each showing an example of a state in which an inclination of the holder 13 has been changed from the state shown in FIG. 4. In each of FIG. 6 and FIG. 7, the cover 15 is indicated by a dashed line, and the optical fiber 21 is not shown, as in FIG. 4.

In the example shown in FIG. 6, the screw 46 on the left side of the holder 13 is inserted into one first hole 16 formed in the second row from the bottom among the plurality of first holes 16 formed in the base portion 14. The screw 46 on the right side of the holder 13 is inserted into one first hole 16 formed in the lowermost row. Thus, the inclination of the holder 13 can be adjusted such that the second positioning portion 52 is lowered with respect to the first positioning portion 51.

In the example shown in FIG. 7, the screw 46 on the left side of the holder 13 is inserted into one first hole 16 formed in the lowermost row among the plurality of first holes 16 formed in the base portion 14. The screw 46 on the right side of the holder 13 is inserted into one first hole 16 formed in the second row from the bottom. Thus, the inclination of the holder 13 can be adjusted such that the second positioning portion 52 is raised with respect to the first positioning portion 51. In this manner, since the plurality of first holes 16 are aligned in the vertical direction and the horizontal direction, the inclination of the holder 13 can be adjusted by selecting the first holes 16 with which the screws 46 are to be engaged.

Here, as shown in FIG. 6, two through holes 47 are formed in the extension portion 55 of the holder 13, and the screw 46 penetrates through each of the two through holes 47. At least one of the two through holes 47 has an elongated hole shape and extends in a direction along a straight line passing through the two screws 46. In the example shown in FIG. 6, the through hole 47 positioned on the right side has an elongated hole shape. This makes it possible to change the distance between the two screws 46. Thus, even when the distance between the two first holes 16 selected in accordance with the inclination of the holder 13 changes, each of the two screws 46 can be engaged with a respective one of the two first holes 16.

The holder 13 may be provided with a latch, a magnet, or the like as a fixing portion instead of the screw 46. For example, when a latch is provided as the fixing portion in the holder 13, a hole engageable with the latch is formed as the attachment portion in the base portion 14. For example, when a magnet is provided as the fixing portion in the holder 13, another magnet engageable with the magnet is provided as the attachment portion in the base portion 14.

The optical fiber cable 22 fixed to the holder 13 is not limited to an optical fiber cable including the tension member 25, and may be an optical fiber cable without including the tension member 25.

The base portion 14 is not limited to the configuration in which the first holes 16 aligned in both the vertical direction and the horizontal direction are formed, and may have a configuration in which the plurality of first holes 16 aligned in the vertical direction or the horizontal direction are formed. For example, when a length of the housing 10 in the vertical direction is short, only the plurality of first holes 16 aligned in the horizontal direction may be formed in the base portion 14 attached to the housing 10.

Furthermore, the optical panel 100 shown in FIG. 1 includes the plurality of housings 10 stacked in the vertical direction, but the optical panel 100 according to the present disclosure may include the plurality of housings 10 arranged in the horizontal direction, or may include a single housing 10.

### [Arrangement Method of Optical Fiber]

Referring again to FIG. 2, when connecting the optical fiber 21 to the adapter 11 in the optical panel 100, an operator first guides the optical fiber cable 22 to the holder 13 through the insertion hole 17 formed in the cover 15. The operator then fixes the optical fiber cable 22 to the positioning portion 41 of the holder 13.

Next, as shown in FIG. 4 to FIG. 7, the operator selects the first holes 16 into which the screws 46 of the holder 13 are to be inserted from the plurality of first holes 16 formed in the base portion 14 such that the radius of curvature at or near the portion of the optical fiber cable 22 at which the optical fiber is led becomes large. The operator then inserts the screws 46 of the holder 13 into the selected first holes 16, thereby fixing the holder 13 and the optical fiber cable 22 to the housing 10. Since the positions and inclinations of the holder 13 and the optical fiber cable 22 with respect to the housing 10 can be adjusted in this manner, bending strain applied to an area of or near the portion of the optical fiber cable 22 at which the optical fiber is led can be reduced.

Referring again to FIG. 2, the operator bends the optical fiber 21, which is led from the optical fiber cable 22 fixed by the holder 13, within the range of the allowable bending angle of the optical fiber 21, and fixes the optical fiber 21 to the first fiber fixing portion 19 provided close to the second positioning portion 52.

The operator guides the optical fiber 21 to the opening 18 formed at the substantially center of the back surface 12 of the housing 10, and causes the second fiber fixing portion 20 provided close to the opening 18 to hold the optical fiber 21. The operator then arranges the optical fiber 21 inside the housing 10. Thus, the optical connector attached to a distal end of the optical fiber 21 can be connected to the adapter 11.

In the embodiment shown in FIG. 1 to FIG. 7, the holder 13 is mounted outside the back surface 12 of the housing 10, but the holder 13 is not limited to such a configuration and may be mounted inside the back surface 12, for example.

The holder 13 is not limited to the configuration in which the holder 13 is mounted on the back surface 12 of the housing 10, and may be mounted inside a bottom surface 26 of the housing 10, for example. That is, the base portion 14 on which the holder 13 is mounted may be provided along the bottom surface 26 inside the bottom surface 26 of the housing 10. In this case, the plurality of first holes 16 formed in the base portion 14 are aligned, for example, in the front-back direction and the horizontal direction of the housing 10. Thus, the position and the inclination of the holder 13 can be adjusted in the front-back direction and the horizontal direction.

However, as described above, the optical fiber 21 is arranged inside the housing 10. Thus, by mounting the holder 13 outside the housing 10, the mounting position of the holder 13 can be set more flexibly than in a case where the holder 13 is mounted inside the housing 10.

Although the present disclosure has been described above based on specific embodiments, the present disclosure is not limited to these examples, and is defined by the scope of the claims, and is intended to include all modifications within the meaning and scope equivalent to the scope of the claims.

### REFERENCE SIGNS LIST

10, 10A, 10B, 10C housing
11 adapter
12 back surface
13 holder
14 base portion
15 cover
16 first hole
17 insertion hole
18 opening (fiber introduction port)
19 first fiber fixing portion
20 second fiber fixing portion
21 optical fiber
22, 22A, 22B, 22C optical fiber cable
24 jacket
25 tension member
26 bottom surface
31A, 31B mount angle
32 tray
41 positioning portion
42 attachment portion
43 supporting portion
44 fitting portion
45 second hole
46 screw (fixing portion)
47 through hole
51 first positioning portion
52 second positioning portion
53 coupling portion
54 plate portion
55 extension portion
100 optical panel

1. An optical panel comprising:
a holder configured to hold an optical fiber cable; and
a housing configured to allow an optical fiber led from the optical fiber cable to be arranged inside the housing,
wherein the housing is provided with a plurality of attachment portions,
wherein the holder includes a plurality of fixing portions engageable with the attachment portions of the housing, and
wherein the number of the attachment portions is greater than the number of the fixing portions.

2. The optical panel according to claim 1,
wherein the plurality of attachment portions are aligned in two directions differing from each other.

3. The optical panel according to claim 1,
wherein the holder is mounted outside the housing.

4. The optical panel according to claim 1,
wherein the holder further includes
a positioning portion configured to secure a position of the optical fiber cable, and
a supporting portion to which the fixing portions are attached, the supporting portion being configured to support the positioning portion, and
wherein an orientation of the positioning portion with respect to the supporting portion is changeable.

5. The optical panel according to claim 1,
wherein the optical fiber cable is held outside the housing by the holder,
wherein the housing has a fiber introduction port at a center of a surface of the housing at which the holder is provided, and
wherein the optical panel further comprises
a first fiber fixing portion configured to retain the optical fiber led from an end portion of the optical fiber cable held by the holder such that the optical fiber extends toward the fiber introduction port, and
a second fiber fixing portion configured to retain the optical fiber introduced into the fiber introduction port, the second fiber fixing portion being provided close to the fiber introduction port inside the housing.

6. The optical panel according to claim 1,
wherein the optical fiber cable is held outside the housing by the holder, and
wherein the optical panel further comprises
a cover configured to cover a portion of the optical fiber led from the optical fiber cable, the portion being located outside the housing.
